(19) United States
(12) Patent Application Publication
(10) Pub. No.: US 2012/0267486 A1
(43) Pub. Date: Oct. 25, 2012

(54) ADJUSTABLE FLOWER POT SUPPORT

(75) Inventors: ERIC DANIEL HYP, Harrisburg, PA (US); Judy Hoysak, Philadelphia, PA (US)

(73) Assignee: AMES TRUE TEMPER, INC., CAMP HILL, PA (US)

(21) Appl. No.: 13/089,367

(22) Filed: Apr. 19, 2011

(51) Int. Cl. A47G 7/02; F16M 11/10; F16M 13/00

(52) U.S. Cl. 248/122.1; 248/313; 248/291.1

(57) ABSTRACT

A flower pot holder includes a collapsing frame assembly that moves between two configurations; an open configuration and a drawn-in configuration. In the first configuration, the frame assembly is spaced from a central axis, over which a flower pot is disposed. In the second configuration, members of the frame assembly are moved toward the central axis of the frame assembly, thereby engaging and holding the flower pot. Moreover, the force that causes the frame assembly to move from the first configuration to the second configuration is the weight of the flower pot; that is, as a user places the flower pot on the frame assembly, the frame assembly automatically moves to the second configuration to grip the flower pot.

### BACKGROUND OF THE INVENTION

1. Field of the Invention

The present invention relates to an adjustable flower pot support and, more specifically, to an adjustable flower pot support having a collapsing frame assembly that engages the flower pot.

2. Description of the Related Art

Flower pots, and other decorations, such as, but not limited to, glass balls, reflective balls, clear bowls filled with marbles, and so forth, are often displayed at a raised location. Thus, initially, it is noted that “flower pot” is intended to be interpreted broadly as any pot, or a similar construct, that may be used to grow flowers, even if used for another purpose, e.g. a pot of dried flowers. The flower pots may have any shape, e.g. spherical, cubical, rectangular, etc., but are commonly an inverted, truncated cone. Such flower pots typically, but not always, have a rim about the upper portion. As shown in the figures, the flower pot is a typical inverted, truncated cone with a rim, however, the disclosed device may be used with flower pots having any shape.

The flower pot may be placed in the raised location by various devices such as, but not limited to, a floor stand, a wall mount, or a hanger assembly. A floor stand may be as simple as a table. A wall mount typically includes a hoop or platform through which, or on which, the flower pot is placed. A hanger typically includes a plurality of tension members (chains, etc.) structured to be coupled to the flower pot or coupled to a hoop through which a flower pot is placed and supported by a ceiling hook. Each type of support has a disadvantage.

A floor stand, such as a table, typically does not include a device that prevents the flower pot from being moved. As such, pets, children, or natural forces such as the wind, may cause the flower pot to be moved off the support or tipped over thereon. Other floor stands specifically designed to hold flower pots may include one or more indentations sized to accommodate a flower pot of a common size. As such, flower pots that are larger than the indentation will not fit therein, and flower pots that are smaller than the indentation may be tipped over within the indentation. That is, such stands are not structured to accommodate flower pots of different sizes. Wall mounts, typically, have a hoop or platform on which a flower pot is placed. These devices can also only accommodate flower pots within a narrow range of sizes that fit in/on the hoop/platform. Moreover, flower pots can easily be knocked off such platforms by various forces.

Two typical types of hangers include three tension members coupled to the flower pot rim or a hoop, and, a net, commonly a macramé net. Each of these has a disadvantage. If one has the tension members suspended, one must support the flower pot while attempting to couple the tension members to the rim or hoop. If the tension members are not supported, the tension members tend to decouple while one is attaching another tension member. Further, for certain plants, such as ferns, the plant may extend over the rim making the coupling between the flower pot and the tension members difficult to access. Some tension members include a resilient clip at the lower ends. These clips must be strong so as to resist becoming detached from the flower pot accidentally. This, however, means that the clips are difficult to remove when a user wants to detach the hanger from the flower pot. Net based hangers typically are not attached to the flower pot, rather, the net acts as a hammock in which the flower pot rests. As the flower pot is not attached to the hanger, the flower pot's orientation may shift and the flower pot may become tilted to the point it allows dirt or other contents to fall from the flower pot. Further, the netting, which is typically fibrous tension members (string) is more likely to be damaged by dirt and other debris infiltrating into the body of the tension member and cutting fibers.

### SUMMARY OF THE INVENTION

The disclosed and claimed concept provides for a flower pot holder that does not have the disadvantages of the prior art. The flower pot holder includes a collapsing frame assembly that moves between two configurations; an open configuration and a drawn-in configuration. In the first configuration, the frame assembly is spaced from the central axis, wherein a flower pot is disposed. In the second configuration, members of the frame assembly are moved toward the central axis of the frame assembly, thereby engaging and holding the flower pot. Moreover, the force that causes the frame assembly to move from the first configuration to the second configuration is the weight of the flower pot; that is, as a user places the flower pot on the frame assembly, the frame assembly automatically moves to the second configuration to grip the flower pot. Further, the center of gravity of the moving frame assembly members are positioned so that when the flower pot is lifted, the frame assembly returns to the first configuration. Thus, the collapsible frame assembly automatically opens and closes as a user inserts/removes a flower pot.

The collapsing frame assembly utilizes generally rigid frame members. The frame members include a pivot support frame, at least one pivoting arm, and at least one flower pot support. The pivot support frame may be a hoop through which the flower pot is inserted. The pivot support frame is coupled to a fixed member, such as a floor stand assembly, a wall mount assembly and a hanger assembly. The pivoting arm has a medial pivot coupling that is pivotally coupled to the pivot support frame. Further, the flower pot support arm has an upper portion and a lower portion. The lower portion is disposed below the hoop. The support arm upper portion extends outwardly from the hoop. When a flower pot is placed through the hoop, the flower pot engages the pivoting arm lower portion. The weight of the flower pot causes the pivot arm to pivot bringing the pivot arm upper portion toward the flower pot. The pivot arm upper portion engages and grips the flower pot. While this embodiment is functional, and while the hoop may be made larger than typical flower pots, the size of the flower pot that may be used is still limited by the size of the hoop.

In another embodiment, which only functions with a hanger assembly as a fixed member; the pivot support frame and the flower pot support are combined into a platform, typically a circular disk. The pivot arm pivot coupling is disposed at the lower end of the pivot arm rather than at a medial location. The pivot arms are pivotally coupled to the pivot support frame/flower pot support and extend outwardly. The hanger assembly includes tension members that are coupled to the upper ends of the pivoting members. As before, when a flower pot is placed on the flower pot support, the weight of the flower pot causes the pivot arms to move inwardly until they engage and grip the flower pot.

### BRIEF DESCRIPTION OF THE DRAWINGS

FIG. 1 is an isometric view of a flower pot holder.

FIG. 2 is a side view of the flower pot holder of FIG. 1 in a first configuration.

FIG. 3 is a side view of the flower pot holder of FIG. 1 in a second configuration.

FIG. 4 is a front view of another embodiment of the flower pot holder.

FIG. 5 is a front view of the flower pot holder of FIG. 4 in the second configuration.

FIG. 6 is an isometric view of another embodiment of the flower pot holder.

FIG. 7 is a side view of another embodiment of the flower pot holder in FIG. 6.

FIG. 8 is a side view of another embodiment of the flower pot holder in FIG. 6 in a second configuration.

FIG. 9 is an isometric view of another embodiment of the flower pot holder.

FIG. 10 is a side view of another embodiment of the flower pot holder in FIG. 9.

FIG. 11 is a side view of another embodiment of the flower pot holder in FIG. 9 in a second configuration.

FIG. 12 is an isometric view of another embodiment of the flower pot holder.

FIG. 13 is a detail view of a pivot assembly.

FIG. 14 is a detail view of a unitary pivot.

### DETAILED DESCRIPTION

As used herein, a “generally rigid” member means that it is structured to generally maintain its shape when exposed to force and is self supporting. A “generally rigid” member may be very rigid, such as but not limited to, a steel rod, or may be slightly flexible, such as but not limited to a thin plastic member, e.g. a disposable plastic knife. Further, a “tension member” such as a rope, chain, or thin cable, is not a “generally rigid” member.

As used herein, “spaced” and “close” are terms describing the relative distance between two elements. That is, when two elements are “close,” they are closer together than when they are “spaced,” regardless of the actual distance between the “close” and “spaced” positions.

As used herein, a “sidewall contact portion” is structured to contact a very generally vertical sidewall, i.e. a sidewall at greater than 45 degrees to horizontal. A “sidewall contact portion” may contact a flower pot rim, including the underside of the rim, but is not structured to do so.

As used herein, “coupled” means a link between two or more elements, whether direct or indirect, so long as a link occurs.

As used herein, “directly coupled” means that two elements are directly in contact with each other.

As used herein, “fixedly coupled” or “fixed” means that two components are coupled so as to move as one while maintaining a constant orientation relative to each other. The fixed components may, or may not, be directly coupled.

As used herein, the word “unitary” means a component is created as a single piece or unit. That is, a component that includes pieces that are created separately and then coupled together as a unit is not a “unitary” component or body.

As used herein, a “unitary pivot” is a unitary component that is structured to act like a pivot. This is accomplished by utilizing elements such as, but not limited to, living hinges or positioning a generally rigid member so that stress is applied to a localized portion of the generally rigid member causing the generally rigid member to flex at that location.

As used herein, a “pivot assembly” is any assembly having two or more components structured to create a pivoting motion.

As used herein, a component “structured to pivot” and/or a “pivot coupling” may be either a “unitary pivot” or a pivot assembly.

Flower pots are typically conical or circular in cross-section. Flower pots may, however, be any shape and square flower pots are not uncommon. The description below assumes a flower pot that is conical or circular in cross-section. As used herein, descriptive words that relate to a circle, e.g. radius, are to be interpreted broadly and are applicable to non-circular shapes.

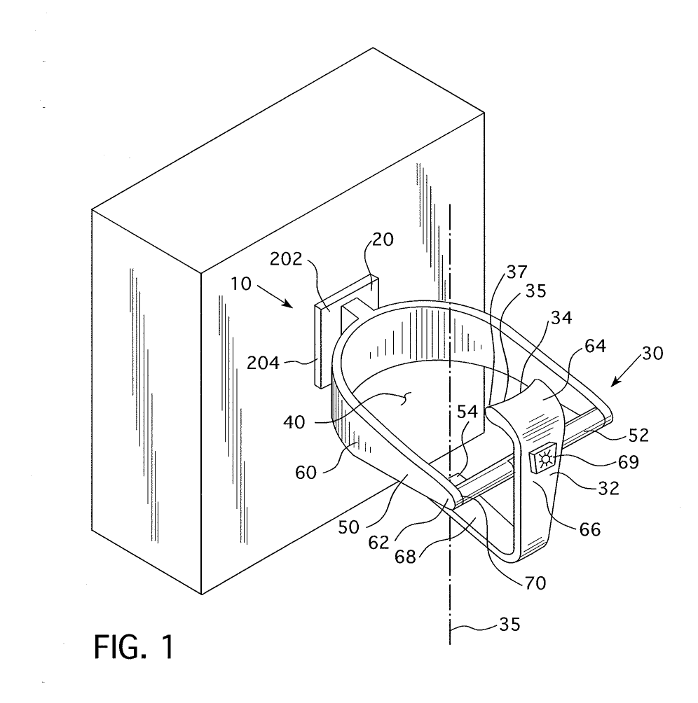

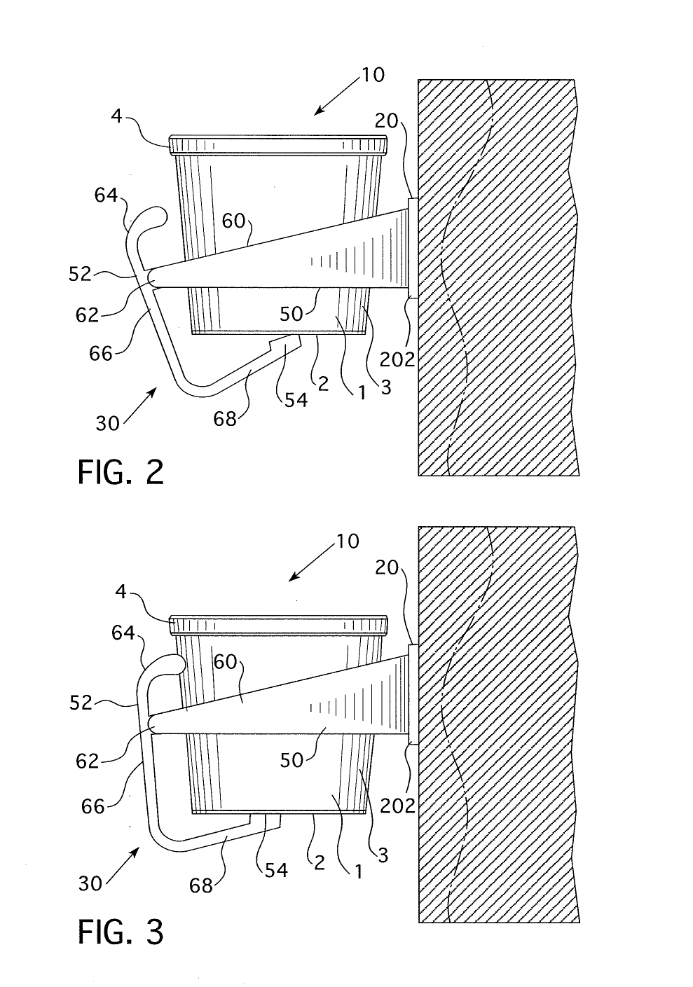

As shown in FIGS. 1-3, a flower pot holder 10 is shown. FIG. 1 shows the flower pot holder 10 empty, FIG. 2 shows the flower pot holder 10 in a first configuration just as a flower pot 1 is placed therein, and FIG. 3 shows the flower pot holder 10 in the second configuration wherein the flower pot 1 is supported and engaged by the flower pot holder 10. “Engaged” meaning held by a member that is generally, laterally biased against the flower pot 1. A typical flower pot 1 is a truncated, inverted cone that is closed, or substantially closed on one end. Alternatively, the flower pot 1 may be described as having a base 2 and an upwardly depending sidewall 3. Further, the flower pot 1 may have, but does not always have, a rim 4; the rim 4 being a flange located at the distal end of the sidewall 3 and extending generally perpendicular to the axis of the flower pot 1. The flower pot holder 10 includes a fixed member 20 and a folding frame assembly 30 coupled to the fixed member 10. There are several embodiments of the flower pot holder 10, but in each embodiment the folding frame assembly 30 has an axis 35 and at least one frame member 32 having a flower pot contact portion 34. The at least one frame member 32 is structured to pivot relative to the fixed member 20. As discussed below, the at least one frame member 32 is pivotally coupled to a pivot support frame 50 and directly pivots relative thereto. The pivot support frame 50, however, is coupled to the fixed member 20, therefore, the at least one frame member 32 is also structured to pivot relative to the fixed member 20. The folding frame assembly 30 is structured to move between a first, extended configuration, wherein the at least one frame member flower pot contact portion 34 is spaced from an axis 35, and a second, drawn-in configuration, wherein the at least one frame member flower pot contact portion 34 is close to the axis 35. The axis 35 is a generally vertical axis 35 that extends through the general center of the folding frame assembly 30. That is, as discussed below, a flower pot 1 is placed in the folding frame assembly 30 and the center of the flower pot 1 is disposed at about the axis 35. Thus, as the flower pot 1 is disposed in the folding frame assembly 30, the folding frame assembly 30 moves from the first configuration to the second configuration, thereby engaging the flower pot 1.

The at least one frame member 32 is a generally rigid member. That is, the at least one frame member 32 is not a tension member. As discussed below, the folding frame assembly 30 is structured to react to the weight of the flower pot 1 and anything contained therein. Thus, the folding frame assembly 30 is structured to move from the first configuration to the second configuration when a flower pot 1 is disposed on the folding frame assembly 30; the weight of the flower pot 1 being the force that causes the folding frame assembly 30 to move from the first configuration to the second configuration. It is further noted that the folding frame assembly 30, and more specifically, the at least one frame member 32 is structured to engage the side of a flower pot 1. That is, the at least one frame member 32 does not have to contact, or engage, the underside of the rim 4 of a flower pot 1, as is known. Thus, the at least one frame member flower pot contact portion 37 is a “sidewall contact portion” 35 as defined herein.

Generally, the folding frame assembly 30 defines a receiving space 40 for the flower pot 1. The receiving space 40 has a greater cross-sectional area, i.e. typically a greater diameter, when the folding frame assembly 30 is in the first configuration and a smaller cross-sectional area, or a smaller diameter, when the folding frame assembly 30 is in the second configuration. The at least one frame member flower pot contact portion 34 is structured to contact a flower pot 1 disposed in the receiving space 40 when the folding frame assembly 30 is in the second configuration. This means that the folding frame assembly 30 is typically structured to accommodate a flower pot 1 of any size, so long as that size is smaller than the receiving space 40 when the folding frame assembly 30 is in the first configuration.

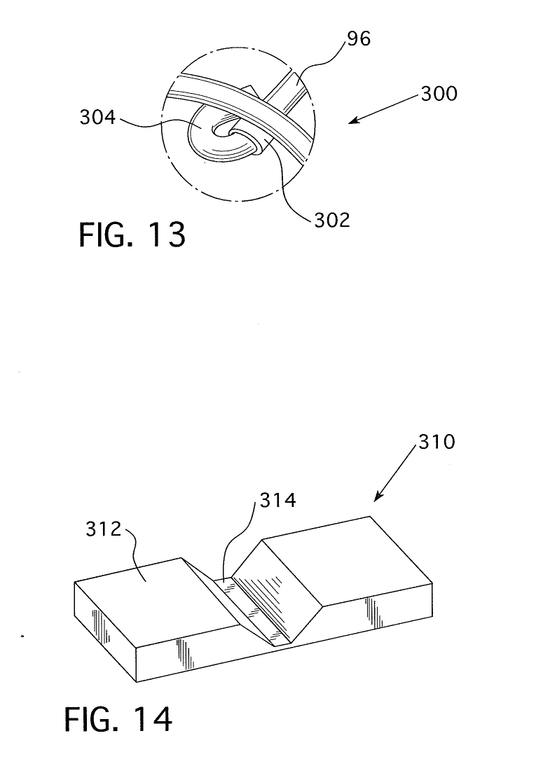

Before discussing specific embodiments, it is noted that each embodiment recites a “pivot coupling.” A pivot coupling may be any type of “unitary pivot” or a “pivot assembly” as defined herein. Preferably, however, the pivot coupling is a simple pivot assembly having a first component, such as, but not limited to a loop/circular opening, and a second component, such as a circular rod, structured to be rotatably disposed in the loop/circular opening, as shown in FIG. 13 and discussed below. The loop/circular opening is disposed on one pivoting component and the rod is disposed on, or extends from, the other component. The position of the loop/circular opening and the rod are generally reversible.

A first embodiment of the flower pot holder 10 is shown in FIGS. 1-3. All embodiments of the folding frame assembly 30 includes a pivot support frame 50, at least one pivoting arm 52 (being the at least one frame member 32 structured to pivot relative to the fixed member 20), and at least one flower pot support 54. The flower pot support 54 is structured to support the flower pot 1. The at least one frame member flower pot contact portion 34 is disposed on the at least one pivoting arm 52. In the first embodiment, the pivot support frame 50 is a hoop 60 having at least one pivot coupling 62 thereon. The at least one pivoting arm 52 has an upper end 64, a medial portion 66, and a lower end 68. The at least one frame member flower pot contact portion 34 is disposed on the at least one pivoting arm upper end 64 and may be adapted to the shape of the flower pot 1, as shown. The at least one pivoting arm medial portion 66 has a pivot coupling 70 thereon as well. The pivot support frame at least one pivot coupling 62 is structured to be pivotally coupled to the at least one pivoting arm medial portion pivot coupling 70. The at least one pivoting arm lower end 68 is the flower pot support 54. That is, the at least one pivoting arm lower end 68 is structured to contact the flower pot base 2 and may be rounded or spherical. The rounded or spherical shape allows the at least one pivoting arm lower end 68 to move smoothly over the flower pot base 2 as the folding frame assembly 30 moves between configurations. The at least one pivoting arm lower end 68 may have a greater area than the other portion of the at least one pivoting arm 52 so as to provide a platform for the flower pot 1.

The at least one pivoting arm medial portion pivot coupling 70 is pivotally coupled to the pivot support frame at least one pivot coupling 62. In this configuration, the at least one pivoting arm 52 is structured to move between the two folding frame assembly 30 configurations described above and as shown in ghost (the first configuration) in FIG. 1. That is, as a user places a flower pot 1 in the pivot support frame 50, as shown in FIG. 2, the flower pot base 2 contacts the at least one pivoting arm lower end 68. This, in turn, causes the at least one pivoting arm 52 to pivot about the pivot support frame at least one pivot coupling 62 moving the at least one frame member flower pot contact portion 34 into engagement with the flower pot 1, as shown in FIG. 3. That is, when the folding frame assembly 30 is in the first configuration, the at least one pivoting arm lower end 68 extends under the pivot support frame 50 and is disposed at a location close to the pivot support frame 50, and, the at least one pivoting arm upper end 64 is disposed at a location outwardly spaced from the pivot support frame 50. When the folding frame assembly 30 is in the second configuration, the at least one pivoting arm lower end 68 is disposed at a location spaced from the pivot support frame 50, and, the at least one pivoting arm upper end 64 is disposed at a location outwardly, but close to, the pivot support frame 50 and with the at least one frame member flower pot contact portion 34 engaging the flower pot 1.

Preferably, the at least one pivoting arm 52 has a center of gravity that is disposed on the outer side of the pivot support frame 50 at least one pivot coupling 62. In this configuration, the at least one pivoting aim 52 will tend to move to a first, open configuration when the at least one pivoting arm lower end 68 is not engaged by a flower pot 1. If required, a lug 69, preferably a decorative lug, may be placed on the at least one pivoting arm 52 as needed to reposition the center of gravity.

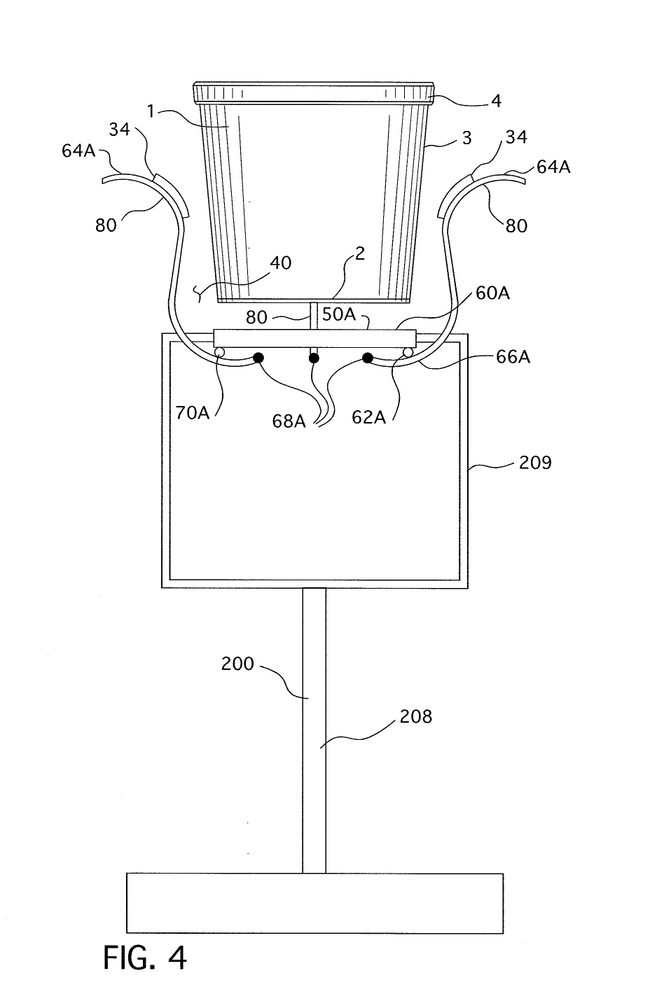

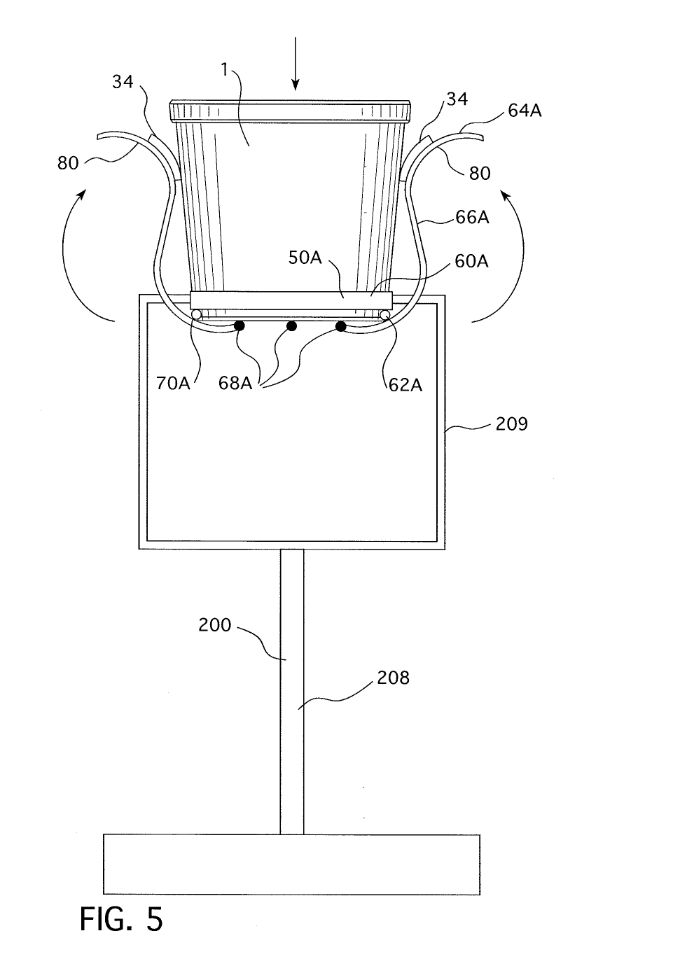

An alternate version of the first embodiment is shown is FIG. 4-5. As before, the pivot support frame 50A is a hoop 60A having at least one pivot coupling 62A thereon. In this version, the at least one pivoting arm 52 is an S-shaped member 80, and preferably three S-shaped members 80. Each S-shaped member 80 has an upper end 64A, a medial portion 66A, and a lower end 68A. Further, the at least one frame member flower pot contact portion 34 is disposed on each S-shaped member upper end 64A. The S-shaped member medial portion 66A has a pivot coupling 70A associated with each S-shaped member 80. That is, if there are three S-shaped members 80, there are three pivot couplings 62A on the pivot support frame 50A pivot support frame pivot coupling 62A associated with one S-shaped member pivot coupling 70A. Each S-shaped member lower end 68A is the flower pot support 54. That is, the S-shaped member lower ends 68A collectively support the flower pot 1. This version operates in a manner similar to the version in FIGS. 1-3, as is shown in FIGS. 4-5.

It is noted that, as shown, the S-shaped members 80 extend generally radially relative to the circular hoop 60A. That is, the axis of rotation for each pivot support frame pivot coupling 62A is generally tangent to the hoop 60A. While this may be the most efficient configuration, a decorative motion, e.g. an angled arcuate motion, may be created by providing a pivot support frame pivot coupling 62A wherein the axis of rotation is angled relative to the hoop 60A (not shown).

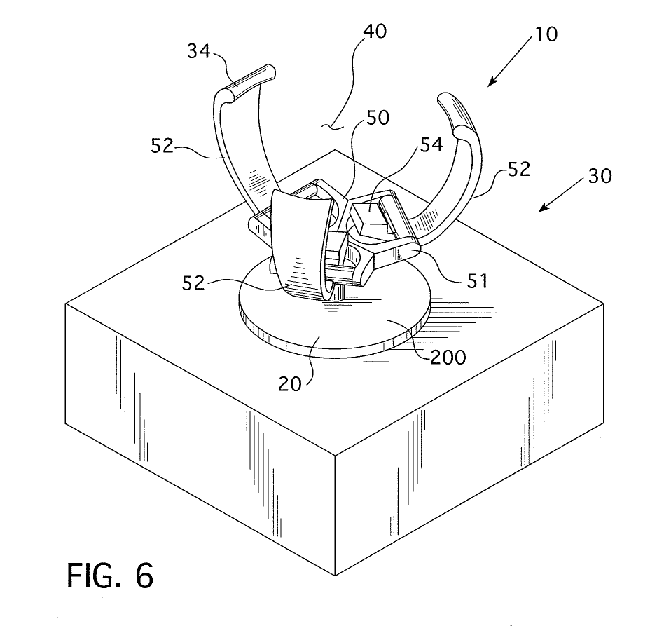

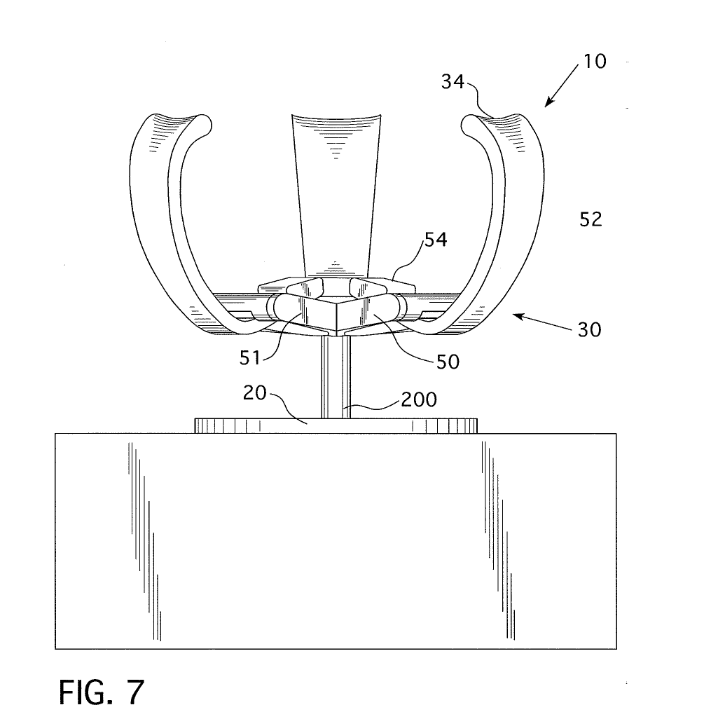

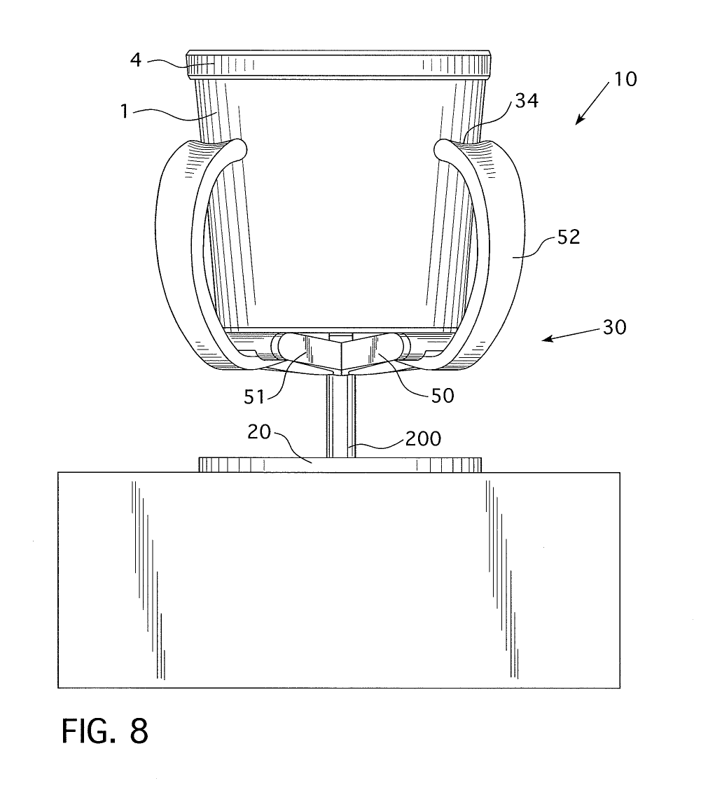

Yet another alternate version of the first embodiment is shown is FIG. 6-8. In this version, a floor stand 200 supports a pivot support frame 50 wherein the support frame 50 defines a yoke 51 for each at least one pivoting arm 52. Each at least one pivoting arm 52 is generally C-shaped having pivot coupling and a flower pot support 54 at the lower end, with the flower pot support 54 at the lower end being closer to the tip of the at least one pivoting arm 52 than the pivot coupling. FIGS. 6 and 7 show the flower pot holder 10 empty, while FIG. 8 shows the flower pot holder 10 engaging a flower pot 1.

It is noted that the fixed member 20 may be selected from the group including a floor stand 200, a wall mount 202, or a hanger assembly 210. A wall mount 202 is shown in FIGS. 1-3 and includes a vertical base 204 and a horizontally extending support arm 206 coupled to the pivot support frame 50. A floor stand 200 is shown in FIGS. 4-5 and includes a pole 208 and a yoke 209; the yoke 209 is coupled to the pivot support frame 50A. The floor stand 200 and the wall mount 202 may be used when the pivot support frame 50 and the at least one flower pot support 54 are not fixed to each other. When the pivot support frame 50 and the at least one flower pot support 54 are fixed to each other, the hanger assembly 210 is preferred as described below. The hanger assembly 210 includes a coupling device 212 and a plurality of descending tension members 214. The hanger assembly coupling device 212 is typically a hook 216 or a loop (not shown) mounted in a ceiling or on a wall.

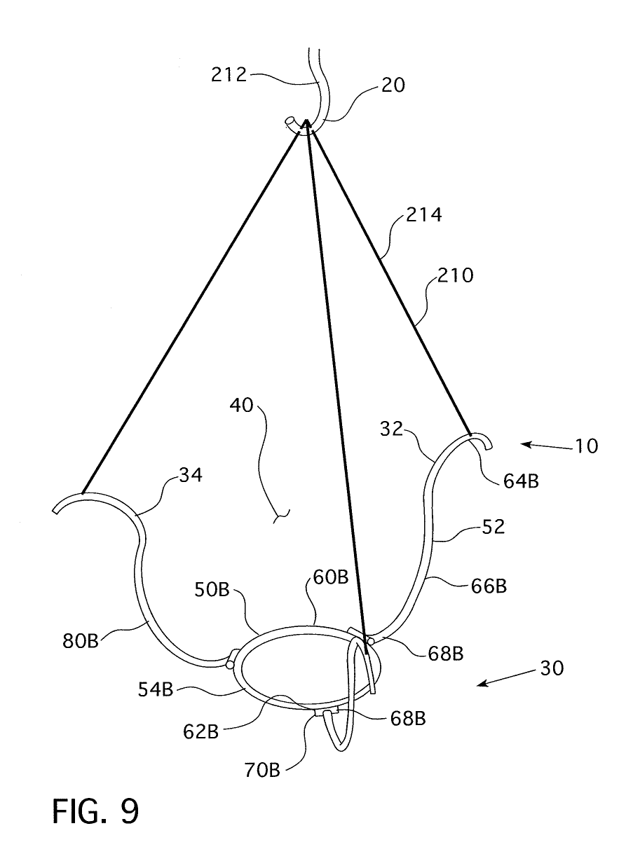

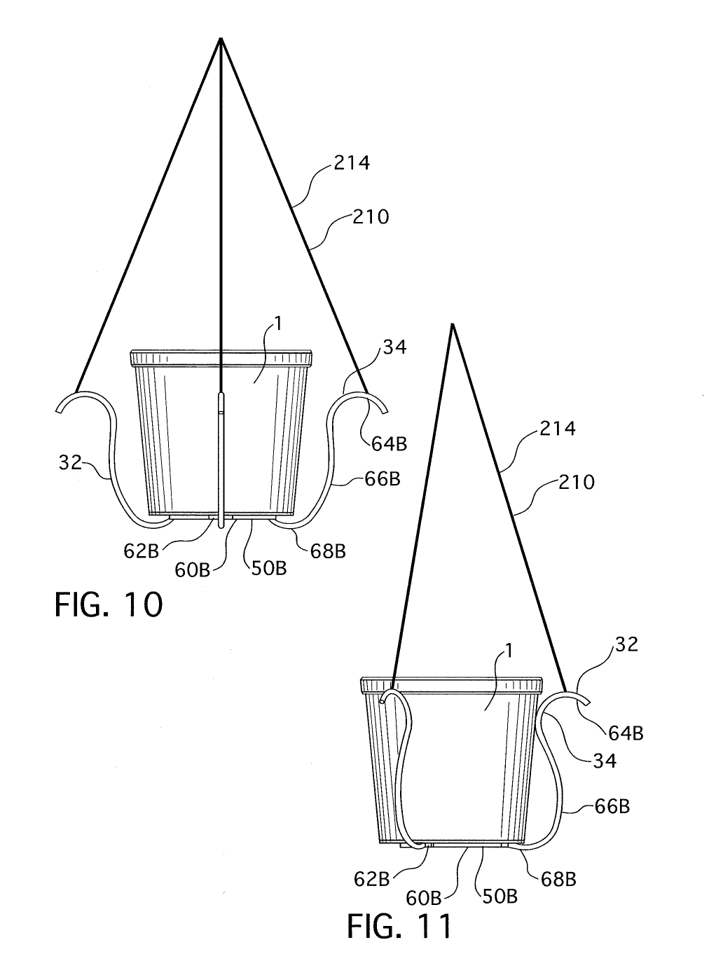

In a second embodiment, shown in FIG. 9-11, the pivot support frame 50B and the at least one flower pot support 54B are fixed to each other, or, may be a unitary body. FIG. 9 shows the flower pot holder 10 in the first configuration, FIG. 10 shows the flower pot holder 10 in the first configuration with a flower pot 1 in the receiving space 40, and FIG. 11 shows the flower pot holder 10 in the second configuration. Preferably, the pivot support frame 50B is, preferably, a planar, circular member 60B, such as hoop (as shown) or a disk (not shown). The pivot support frame 50B has at least one pivot coupling 62B thereon. Preferably, the pivot support frame pivot couplings 62B is disposed generally evenly about the circular member 60B. The at least one pivoting arm 52B, which is again shown as a plurality of S-shaped member 80B, has an upper end 64B, a medial portion 66B, and a lower end 68B. The at least one frame member flower pot contact portion 34 is disposed on the at least one pivoting arm upper end 64B. The at least one pivoting arm lower end 68B has a pivot coupling thereon 70B. The at least one pivoting arm lower end pivot coupling 70B is pivotally coupled to the pivot support frame 50 at least one pivot coupling 62B. As before, there is one pivot support frame pivot coupling 62B associated with each pivoting arm 52B. The hanger assembly tension members 214 are coupled to each pivoting arm 52B, preferably at each pivoting arm upper end 64B.

In this configuration, the weight of each pivoting aim 52B causes each pivoting arm 52B to be pivoted about the pivoting arm lower end pivot coupling 70B away from the pivot support frame 50B. This is the first configuration. When a flower pot 1 is placed on the flower pot support 54, the weight of the flower pot 1 causes the flower pot support 54 to move downwardly away from the hanger assembly 210, which in turn causes each pivoting arm 52B to pivot about the associated pivot support frame pivot coupling 62B until each one frame member flower pot contact portion 34 engages the flower pot 1 and the folding frame assembly 30 is in the second configuration.

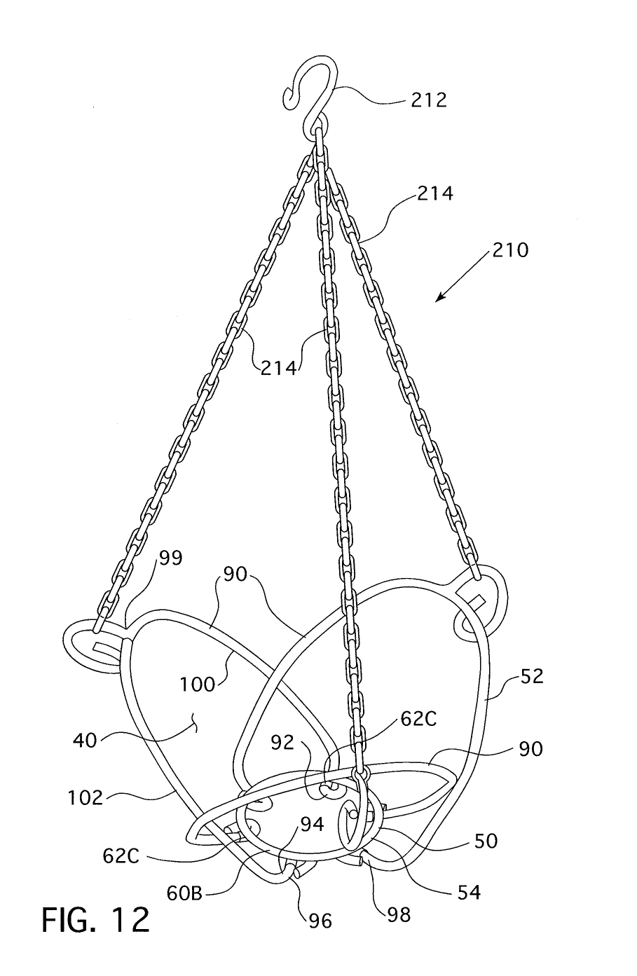

In a second version of this embodiment, shown in FIG. 12, the at least one pivoting arm 52 includes a plurality of arcuate members 90. Unlike the “C-shaped member” discussed above, the arcuate members 90 are pivotally coupled to the pivot support frame 50 at each end. That is, each arcuate member 90 has two ends, a first end 92 and a second end 94. There is a pivot coupling 70C at each arcuate member end 92, 94. As before, the pivot support frame at least one pivot coupling 62C includes a plurality of pivot couplings 62C; in this embodiment there being two pivot couplings 62C for each arcuate member 90. Preferably, the pivot support frame pivot couplings 62C are disposed on opposite sides, i.e. about 180 degrees apart, of the circular member 60B. Therefore, each arcuate member 90 is pivotally coupled to a pair of associated pivot couplings 62C. Further, the hanger assembly tension members 214 are coupled to each arcuate members 90, preferably at the vertex, i.e. the point about equidistant from both ends, of the arcuate members 90. As shown, there are preferably three arcuate members 90. With three arcuate members 90 and with the pivot support frame pivot couplings 62C disposed on opposite sides circular member 60B, the arcuate members 90 will overlap. Preferably, each arcuate member 90 has a first arcuate portion 100 and a second arcuate portion 102. The first arcuate portion 100 is disposed adjacent to the first end 92 and the second arcuate portion 102 is disposed adjacent to the second end 94. Each arcuate member first arcuate portion 100 is disposed inwardly of the overlapping second arcuate portion 102 of an adjacent arcuate member 90. In this configuration, the motion of the arcuate members 90 are limited, that is, the folding frame assembly 30 is self supporting as the arcuate members 90 essentially lean on each other. Finally, it is noted that, while the arcuate members may have any cross-sectional shape, preferably each arcuate member 90 has either a generally circular cross-section or a thin, generally rectangular cross-section. In operation, this version acts as the version described immediately above.

The size of the receiving space 40 may be altered by changing the shape of the pivoting arms 52. That is, the S-shaped members 80, 80B discussed above, allow for the S-shaped members 80, 80B to be spaced from the flower pot 1 at the bottom of the folding frame assembly 30, yet curve inwardly so as to be able to contact the flower pot 1. If the pivoting arms 52 had a different shape, e.g. U-shaped (not shown), wherein the at least one pivoting arm pivot coupling 70 is disposed at the tip of one of the U-shaped member tines and the U-shaped member open end facing toward the pivot support frame 50, the receiving space 40 would be much larger as the U-shaped member upper tip would be spaced further from the pivot support frame 50 in the first configuration when compared to the S-shaped member upper end 64A in the first configuration.

With the arcuate members 90, the size of the receiving space 40 may be increased by providing each arcuate member end 92, 94 with an inwardly extending portion 96, 98. This, effectively, increases the space between the curved portion of the arcuate member 90 and the center of the folding frame assembly 30 which, in turn, increases the size of the receiving space 40. Each pivoting arm lower end pivot coupling 70C is disposed at each the arcuate member inwardly extending portion 96, 98.

FIG. 13 shows a pivot assembly 300 having a loop 302 and a circular member 304 rotatably disposed therein. The circular member 304 is represents a arcuate member inwardly extending portion 96. FIG. 9 shows a living hinge 310 wherein a member 312 having a rectangular cross-section includes a lateral groove 314 creating a location that will bend under less force than the other portions of the member 312.

While a specific embodiment of the invention has been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the appended claims and any and all equivalents thereof.

What is claimed is:

1. A flower pot holder for a flower pot, said flower pot having a body with a base and an upwardly depending sidewall, said flower pot holder comprising:
a fixed member; and
a folding frame assembly coupled to said fixed member, said folding frame assembly having an axis and at least one frame member having a flower pot contact portion, said at least one frame member structured to pivot relative to said fixed member, said folding frame assembly structured to move between a first, extended configuration, wherein said at least one frame member flower pot contact portion is spaced from said axis, and a second, drawn-in configuration, wherein said at least one frame member flower pot contact portion is close to said axis.

2. The flower pot holder of claim 1 wherein said at least one frame member is a generally rigid member.

3. The flower pot holder of claim 1 wherein said folding frame assembly is structured to move from said first configuration to said second configuration when a flower pot is disposed on said folding frame assembly; the weight of the flower pot being the force that causes the folding frame assembly to move from said first configuration to said second configuration.

4. The flower pot holder of claim 1 wherein said at least one frame member flower pot contact portion is a sidewall contact portion.

5. The flower pot holder of claim 1 wherein:
said folding frame assembly defines a receiving space, said receiving space having a greater cross-sectional area when said folding frame assembly is in said first configuration and a smaller cross-sectional area when said folding frame assembly is in said second configuration; and
wherein said at least one frame member flower pot contact portion is structured to contact a flower pot disposed in said receiving space when said when said folding frame assembly is in said second configuration.

6. The flower pot holder of claim 1 wherein:
said folding frame assembly includes a pivot support frame, at least one pivoting arm, and at least one flower pot support;
said flower pot support structured to support said flower pot; and
said at least one frame member flower pot contact portion disposed on said at least one pivoting arm.

7. The flower pot holder of claim 6 wherein:
said pivot support frame is a hoop having at least one pivot coupling thereon;
said at least one pivoting arm has an upper end, a medial portion, and a lower end;
said at least one frame member flower pot contact portion disposed on said at least one pivoting arm upper end;
said at least one pivoting arm medial portion having a pivot coupling thereon;
said at least one pivoting arm lower end being said flower pot support; and
said at least one pivoting arm medial portion pivot coupling pivotally coupled to said pivot support frame at least one pivot coupling.

8. The flower pot holder of claim 7 wherein:
said at least one pivoting arm includes a plurality of S-shaped members;
said pivot support frame at least one pivot coupling includes a plurality of pivot couplings; and
each said S-shaped member being pivotally coupled to an associated pivot coupling.

9. The flower pot holder of claim 7 wherein:
when said folding frame assembly is in said first configuration, said at least one pivoting arm lower end extends under said pivot support frame and is disposed at a location close to said pivot support frame, and, said at least one pivoting arm upper end is disposed at a location outwardly spaced from said pivot support frame; and
when said folding frame assembly is in said second configuration, said at least one pivoting arm lower end is disposed at a location spaced from said pivot support frame, and, said at least one pivoting arm upper end is disposed at a location radially outwardly but close to said pivot support frame.

10. The flower pot holder of claim 7 wherein said fixed member is selected from the group comprising a floor stand assembly, a wall mount assembly and a hanger assembly.

11. The flower pot holder of claim 6 wherein:
said fixed member is a hanger assembly having a coupling device and a plurality of descending tension members;
said pivot support frame includes said flower pot support, said pivot support frame having at least one pivot coupling thereon;
said at least one pivoting arm has an upper end, a medial portion, and a lower end;
said at least one frame member flower pot contact portion disposed on said at least one pivoting arm upper end;
said at least one pivoting arm lower end having a pivot coupling thereon; and
said at least one pivoting arm lower end pivot coupling pivotally coupled to said pivot support frame at least one pivot coupling.

12. The flower pot holder of claim 11 wherein:
said at least one pivoting arm includes a plurality of S-shaped members;
said pivot support frame at least one pivot coupling includes a plurality of pivot couplings; and
each said S-shaped member being pivotally coupled to an associated pivot couplings.

13. The flower pot holder of claim 12 wherein:
said pivot support frame is a planar, generally circular member; and
said pivot couplings disposed generally evenly about said circular member.

14. The flower pot holder of claim 13 wherein:
said at least one pivoting arm includes a plurality of arcuate members, each said arcuate member having two ends;
said pivot support frame at least one pivot coupling includes a plurality of pivot couplings, there being two pivot couplings for each arcuate member; and
each said arcuate member being pivotally coupled to a pair of associated pivot couplings.

15. The flower pot holder of claim 14 wherein:
each arcuate member end includes an inwardly extending portion; and
each said pivoting arm lower end pivot coupling disposed at each said arcuate member inwardly extending portion.

16. The flower pot holder of claim 15 wherein:
said pivot support frame is a planar, generally circular member; and
said pivot couplings disposed generally evenly about said circular member.

17. The flower pot holder of claim 16 wherein said inwardly extending portions of each arcuate member are coupled to opposing sides of said circular member.

18. The flower pot holder of claim 17 wherein:
said plurality of arcuate members includes three arcuate members;
each said arcuate member having a first arcuate portion and a second arcuate portion, said first arcuate portion disposed adjacent said first end and said second arcuate portion disposed adjacent said second end; and
wherein each arcuate member first arcuate portion is disposed inwardly of the overlapping second arcuate portion of an adjacent arcuate member.

19. The flower pot holder of claim 12 wherein each said arcuate member has a generally circular cross-section.

20. The flower pot holder of claim 12 wherein each said arcuate member has a thin, generally rectangular cross-section.

21. The flower pot holder of claim 1 wherein said at least one frame member structured to pivot utilizes a unitary pivot.

22. The flower pot holder of claim 1 wherein said at least one frame member structured to pivot utilizes a pivot assembly.
